(19) United States
(12) Patent Application Publication
(10) Pub. No.: US 2015/0302254 A1
(43) Pub. Date: Oct. 22, 2015

(54) IMAGE OUTPUTTING APPARATUS, IMAGE CAPTURING METHOD BY THE IMAGE OUTPUTTING APPARATUS AND PROGRAM

(71) Applicant: FURYU CORPORATION, Tokyo (JP)

(72) Inventors: Yuki TAJI, Osaka (JP); Michiyo WAKAYOSHI, Shiga (JP); Ryoko INAGAKI, Osaka (JP); Yoshiko TAKEMURA, Kyoto (JP)

(73) Assignee: FURYU CORPORATION, Tokyo (JP)

(21) Appl. No.: 14/575,277

(22) Filed: Dec. 18, 2014

(30) Foreign Application Priority Data
Dec. 20, 2013 (JP) 2013-264363

(51) Int. Cl. G06K 9/00; G06F 3/16; H04N 5/265; G06F 3/0482; G06F 3/0484

(52) U.S. Cl. CPC G06K 9/00664; G06F 3/0482; G06F 3/04842; G06F 3/04845; H04N 5/265; G06F 3/165

(57) ABSTRACT

Provided is an image outputting apparatus that photographs a user as a subject, allows the user to perform edit input to an acquired photographed image, and outputs the photographed image. The image outputting apparatus comprises a photographing condition selection unit that selects a photographing condition related to the photographing, and a music output unit that outputs music corresponding to the selected photographing condition during the photographing.

### BACKGROUND OF THE INVENTION

1. Technical Field

The present disclosure relates to an image outputting apparatus, an image capturing method by the image outputting apparatus, and a program, and particularly to an image outputting apparatus, an image capturing method by the image outputting apparatus, and a program which enable a reduction of effort of a user for selecting BGM.

2. Related Art

A photo sticker machine is known that photographs a user, that allows the user to edit a photographed image, and that prints the edited image on a sticker sheet to provide. Such a photo sticker machine is disposed in amusement (play) facilities.

In a flow of one game provided by the photo sticker machine, typically, the machine photographs a user as a subject in a photographing space, causes the user to move to an edit space, edits the image in accordance with an operation performed in the edit space, and prints an edited image, namely an image on which the editing has been performed, on a sticker sheet.

Some of these photo sticker machines display a series of animation images including photographing timing and guidance information of the photographing during a photographing play and output BGM (background music) and announcement from a speaker in synchronization with the animation images (See, for example, Patent Document 1 (JP 2006-58674 A)).

Recent years, it is known that some photo sticker machines allow a user to select BGM to be output during the photographing operation, and thereby the user can enjoy the photographing by selecting the BGM in accordance with a feeling at the time.

### SUMMARY OF THE INVENTION

However, as options of BGM increase, a user may take much time to search BGM matching the feeling at the time and may consume extra time to select BGM.

In view of such situations, this disclosure provides an image outputting apparatus capable of reducing effort of a user for selecting BGM.

A photo sticker creating apparatus according to one aspect of the present invention is an image outputting apparatus that photographs a user as a subject, allows the user to perform edit input to an acquired photographed image, and outputs the photographed image. The image outputting apparatus includes a photographing condition selection unit that selects a photographing condition related to the photographing, and a music output unit that outputs music corresponding to the selected photographing condition during the photographing.

### BRIEF DESCRIPTION OF DRAWINGS

FIG. 1 is a perspective view of an exemplary configuration of an appearance of a photo sticker creating apparatus according to one embodiment of the present invention.

FIG. 2 is a perspective view of the appearance of the photo sticker creating apparatus viewed from another angle.

FIG. 3 is a diagram for explaining movement of a user.

FIG. 4 is a diagram showing an exemplary configuration of an initial service section.

FIG. 5 is a diagram showing an exemplary configuration of a shooting section.

FIG. 6 is a diagram showing an exemplary configuration of a background section.

FIG. 7 is a diagram showing an exemplary configuration of a front face of an edit unit.

FIG. 8 is a diagram showing an exemplary configuration of a side face of the edit unit.

FIG. 9 is a block diagram showing an internal configuration example of the photo sticker creating apparatus.

FIG. 10 is a block diagram showing an exemplary functional configuration of a control device.

FIG. 11 is a block diagram showing an exemplary functional configuration of an initial service processing unit.

FIG. 12 is a block diagram showing an exemplary functional configuration of a photographing processing unit.

FIG. 13 is a flowchart for explaining an example of a flow of game of a photo sticker creating game

FIG. 14 is a flowchart for explaining an initial service process.

FIG. 15 is a diagram showing an example of a background set selection screen.

FIG. 16 is a diagram showing an example of a BGM selection screen.

FIG. 17 is a diagram showing an example of the BGM selection screen.

FIG. 18 is a flowchart for explaining a photographing process.

FIG. 19 is a diagram showing an example of a photographing screen.

FIG. 20 is a diagram showing an example of the photographing screen.

### DETAILED DESCRIPTION OF EMBODIMENTS

Embodiments according to the present invention will now be described in detail with reference to the drawings.

Configuration of Appearance of Photo sticker Creating Apparatus

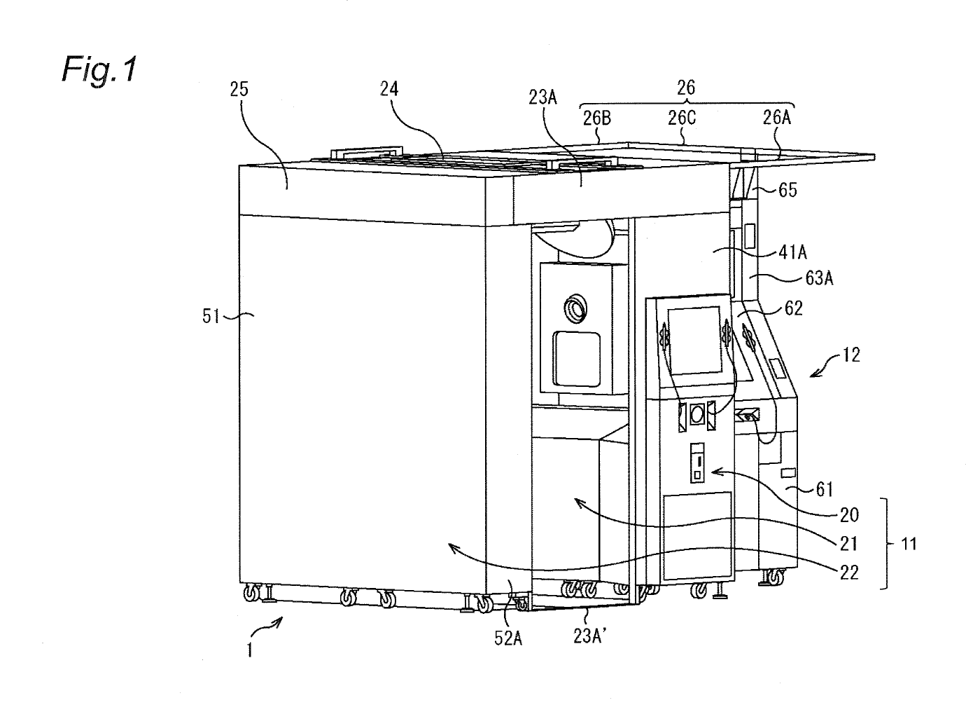

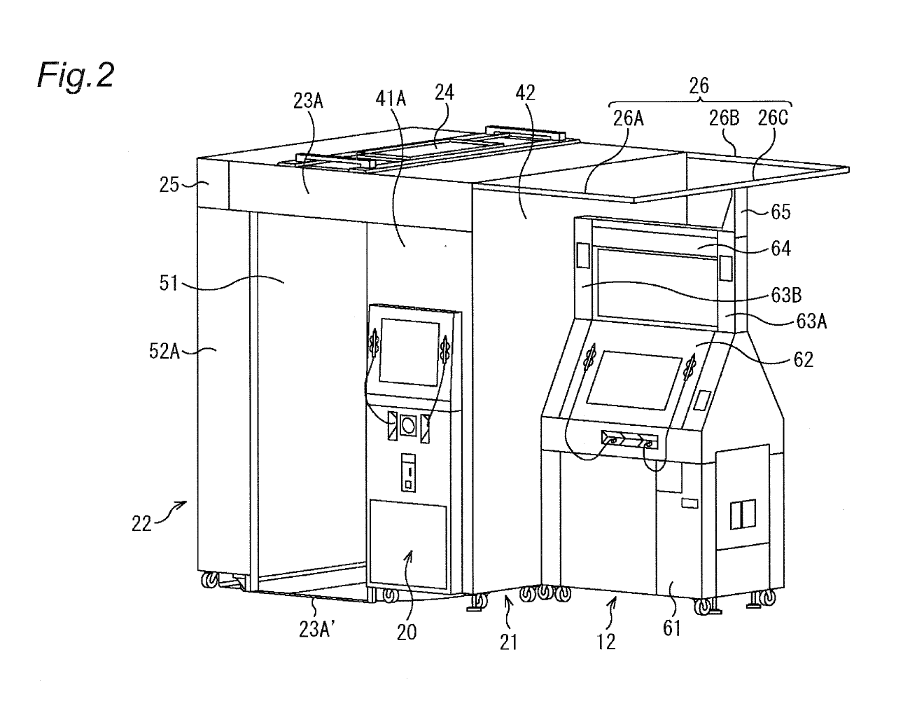

FIGS. 1 and 2 are perspective views of an exemplary configuration of an appearance of a photo sticker creating apparatus 1 (image outputting apparatus).

A photo sticker creating apparatus 1 is a game machine that provides a photographed image or an edited image. The image may be provided in a printed form on a sticker sheet or may be provided such that the image transmitted to a server is made viewable on a user's mobile terminal. The photo sticker creating apparatus 1 is disposed in facilities or stores such as amusement facilities. Main users are assumed to be female high-school students or young females. Though the apparatus may be used by one user, it is typically used by a plurality of users such as two or three per group.

A user playing with the photo sticker creating apparatus 1 photograph themselves as subjects. The user then edits an image selected from photographed images acquired from the photographing by compositing handwritten characters or stamp images with the selected image to create a colorful image from the photographed image. The user receives a sticker sheet having the photographed image or the edited image printed thereon, and then the game ends.

As shown in FIG. 1, the photo sticker creating apparatus 1 is basically configured by a photographing unit 11 and an edit unit 12 which are disposed in contact with each other.

The photographing unit 11 is made up of an initial service section 20, a shooting section 21, and a background section 22. The initial service section 20 is disposed on each of the both side faces of the shooting section 21, and each of spaces in front thereof is defined as an initial service space in which an operation for an initial service process is performed. The shooting section 21 and the background section 22 are spaced at a predetermined distance from each other, and a space formed between the shooting section 21 and the background section 22 is defined as a photographing space in which an operation for a photographing process is performed.

The initial service section 20 is an apparatus that performs the initial service process including providing guidance for introducing the game provided by the photo sticker creating apparatus 1 and performing various settings for the photographing performed in the photographing space. The initial service section 20 is provided with a coin insert slot for receiving a charge from a user and a tablet built-in monitor and stylus pens used for various operations. The initial service section 20 guides a user in the initial service space to the photographing space in accordance with availability of the photographing space.

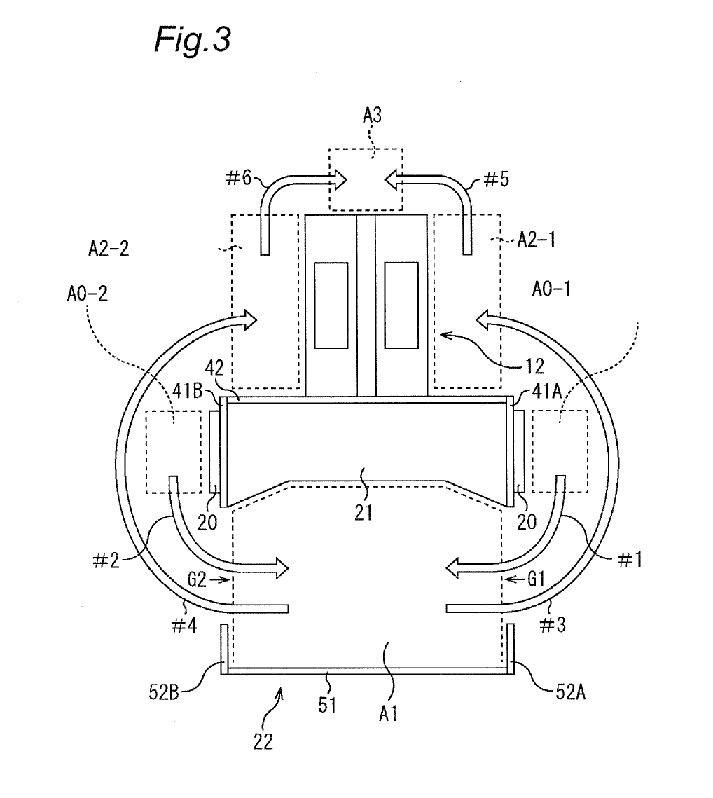

The shooting section 21 is an apparatus for performing the photographing process which photographs the user as a subject. The shooting section 21 is located in front of the user in the photographing space. On a front surface of the shooting section 21 facing the photographing space, a camera and a touch panel monitor used for various operations are disposed. It is assumed that surfaces on the right side and the left side are referred to a right side surface and a left side surface, respectively when viewed from a user in the photographing space. The right side surface and the left side surface of the shooting section 21 are made up of a side panel 41A and a side panel 41B (FIG. 3), respectively, and the front surface is made up of a front panel 42. Each of the side panels 41A and 41B is provided with the initial service section 20.

The background section 22 is made up of a back panel 51 that is a plate-shaped member located on the back side of the user facing the front during the photographing, a side panel 52A that is a plate-shaped member attached to the right end of the back face panel 51 and having a width narrower than the side panel 41A, and a side panel 52B that is a plate-shaped member attached to the left end of the back panel 51 and having a width narrower than the side panel 41B (FIG. 3).

The side panel 41A making up the right side surface of the shooting section 21 and the side panel 52A of the background section 22 are disposed on substantially the same plane. The side panel 41A and the side panel 52A are coupled at upper portions thereof with a coupling member 23A that is a plate-shaped member, and are coupled at lower portions thereof with a coupling member 23A′ that is provided on a bottom and is a member made of metal, for example. The side panel 418 making up the left side surface of the shooting section 21 and the side panel 52B of the background section 22 are similarly disposed on substantially the same plane and are coupled at upper portions thereof with a coupling member 23B (not shown) and are coupled at lower portions thereof with a coupling part 23B (not shown).

An opening surrounded and formed by the side panel 41A of the shooting section 21, the coupling member 23A, and the side panel 52A of the background section 22 is defined as an entrance/exit of the photographing space. An opening surrounded and formed by the side panel 41B of the shooting section 21, the coupling member 23B, and the side panel 52B of the background section 22 is also defined as an entrance/exit of the photographing space.

The upper portion of the background section 22 is provided with a background curtain unit 25 disposed and supported by the back panel 51, the side panel 52A, and the side panel 52B. The background curtain unit 25 houses a background curtain of a predetermined color appearing on the background of a user in a photographed image acquired from the photographing. The background curtain unit 25 lowers, as needed, for example, a green chroma-key curtain in the photographing space, in association with the photographing.

The chroma-key curtain may be attached in advance to the back panel 51 acting as a backplane of the photographing space. If the chroma-key curtain is used as the background for photographing, a plurality of types of background images to be composited are prepared such that a user's desired background image can be composited on the portion of the curtain by performing a chroma-key process in a photographing process or an edit process.

A ceiling surrounded by the front surface of the shooting section 21, the coupling member 23A, the coupling member 23B, and the background curtain unit 25 is defined over the photographing space and a ceiling strobe unit 24 is provided as a portion of the ceiling. One end of the ceiling strobe unit 24 is fixed to the coupling member 23A and the other end is fixed to the coupling member 23B. The ceiling strobe unit 24 has a strobe incorporated therein for emitting light toward the photographing space in synchronization with the photographing. The ceiling strobe unit 24 has a fluorescent light disposed therein in addition to the strobe, so that it also acts as illumination of the photographing space.

The edit unit 12 is a device for performing the edit process of a photographed image. The edit unit 12 is disposed, coupled to the photographing unit 11 with one side surface coming into contact with the back surface of the shooting section 21.

If it is assumed that a configuration of the edit unit 12 shown in FIGS. 1 and 2 is taken as a configuration on the front side, configurations used for editing are provided on the front side and the back side of the edit unit 12 so as to allow two groups of users to perform the editing at the same time.

A front surface side of the edit unit 12 is made up of a surface 61 that is a surface perpendicular to a floor face and substantially parallel to the side panel 41A of the shooting section 21, and a slope 62 formed above the surface 61. The slope 62 is provided with a tablet built-in monitor and stylus pens, as elements used for an edit operation. A column-shaped support member 63A supporting one end of a lighting device 64 is disposed on the right side of the slope 62. A column-shaped support member 63B supporting the other end of the lighting device 64 is disposed on the left side of the slope 62. A supporting member 65 supporting a curtain rail 26 is disposed on an upper surface of the support member 63A.

The curtain rail 26 is attached above the edit unit 12. The curtain rail 26 is made up of three rails 26A to 26C which are composited to be approximately U-shaped when viewed from above. The rails 26A and 26B disposed in parallel are fixed at one ends thereof to the coupling members 23A and 23B, respectively, and are connected at the other ends to the both ends of the rail 26C.

A curtain is attached to the curtain rail 26 to prevent the inside of spaces in front of the front face and the back face of the edit unit 12 from being seen from the outside. The spaces in front of the front face and the back face of the edit unit 12 surrounded by the curtain attached to the curtain rail 26 are defined as edit spaces where a user edits the photographed images.

As described later, a discharge port for discharging a printed sticker sheet is disposed on the right side of the edit unit 12. A space in front of the right side surface of the edit unit 12 is defined as a print waiting space where a user waits for discharge of a printed sticker sheet.

### Movement of User

A flow of a photo sticker creating game and movement of a user associated therewith will be described below. FIG. 3 is a plane view of the photo sticker creating apparatus 1 viewed from above.

First, a user inserts coins into the coin insert slot in an initial service space A0-1 or an initial service space A0-2 each of which is a space formed in front of the initial service section 20, and then performs various settings by using a stylus pen in accordance with a screen displayed on the tablet built-in monitor. In the initial service space A0-1, A0-2, the user performs, for example, selection of conditions related to photographing in the photographing space, as an initial service operation.

After completed the initial service operation, the user enters a photographing space A1 formed between the shooting section 21 and the background section 22 from an entrance/exit G1 as indicated by a while arrow #1 or from an entrance/exit G2 as indicated by a while arrow #2, and then performs photographing by using the camera and the touch panel monitor disposed on the shooting section 21. The entrance/exit G1 is an opening between the side panel 41A and the side panel 52A and the entrance/exit G2 is an opening between the side panel 41B and the side panel 52B.

Two groups of users can perform the initial service operations at the same time in the initial service space A0-1 and the initial service space A0-2, respectively. In this case, a user who finished the initial service operation earlier is first guided to the photographing space A1. In this case, the initial service section 20 provides guidance for the photographing process, and so on to the user who does not finish the initial service operation to keep the user waiting, until the user who entered in advance the photographing space A1 finishes the photographing.

The user who finished the photographing goes out of the photographing space A1 through the entrance/exit G1 as indicated by a while arrow #3 and move to an edit space A2-1, or goes out of the photographing space A1 through the entrance/exit G2 as indicated by a while arrow #4 to and moves to an edit space A2-2.

The edit space A2-1 is the edit space on the front side of the edit unit 12 and the edit space A2-2 is the edit space on the back side of the edit unit 12. The user is guided to move to either the edit space A2-1 or the edit space A2-2 by screen display and so on, on the touch panel monitor of the shooting section 21. For example, available one of the two edit spaces is defined as the destination to which the user is guided. The user moved to the edit space A2-1 or the edit space A2-2 starts editing the photographed image. The user in the edit space A2-1 and another user in the edit space A2-2 can perform the editing at the same time.

After completion of the editing, printing of the photographed image or the edited image is started. When the printing of the image is completed, the user who finished the editing in the edit space A2-1 moves from the edit space A2-1 to a print waiting space A3, as indicated by a white arrow #5. The user who finished the editing in the edit space A2-2 moves from the edit space A2-2 to the print waiting space A3 as indicated by a white arrow #6.

The user arrived at the print waiting space A3 receives a sticker sheet from the discharge port which disposed in the right side surface of the edit unit 12, and then the photo sticker creating game is finished.

The configurations of the apparatuses will be described below.

### Configuration of Initial Service Section

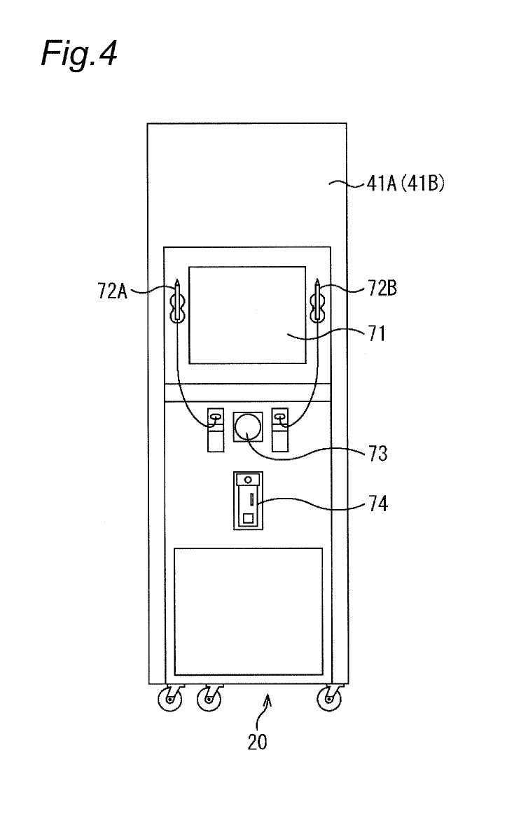

FIG. 4 is a front view showing an exemplary configuration of the initial service section 20 disposed on the side panel 41A (or the side panel 41B).

A tablet built-in monitor 71 is disposed on an upper portion of the initial service section 20. Stylus pens 72A and a stylus pen 72B are disposed on the left side and the right side of the tablet built-in monitor 71, respectively, sandwiching the tablet built-in monitor 71. The tablet built-in monitor 71 is configured with a tablet which enables input of operation with the stylus pen 72A or 72B and is disposed with a display being exposed outside. The tablet built-in monitor 71 displays a screen used for the initial service process such as the course selection and the background selection. When two users perform the initial service operations at the same time with the two users facing the tablet built-in monitor 71, the stylus pen 72A is used by the user on the left side and the stylus pen 72B is used by the user on the right side.

A speaker 73 is disposed under the tablet built-in monitor 71. The speaker 73 outputs sound, such as guidance voice, BGM (background music), and sound effects of the initial service process. A coin insert/return slot 74 used by a user for inserting coins is disposed under the speaker 73.

### Configuration of Shooting Section

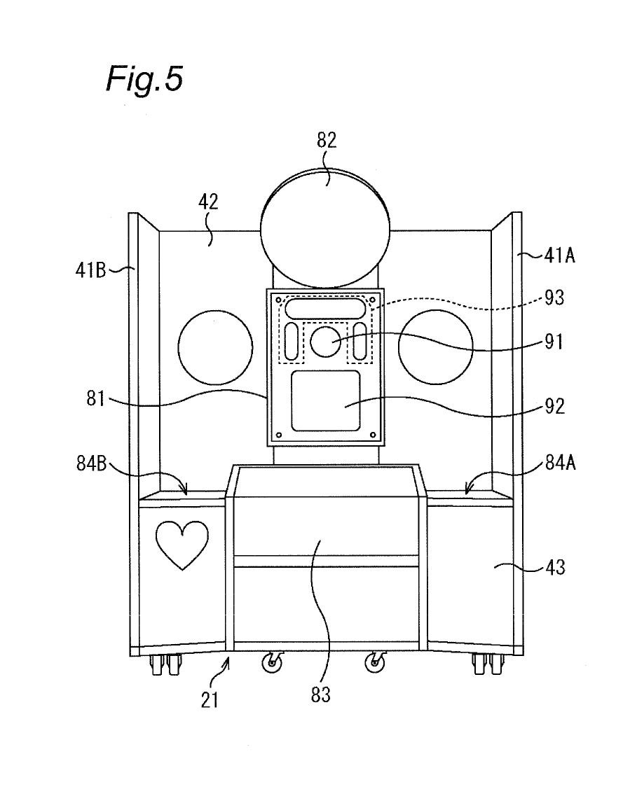

FIG. 5 is a front view showing an exemplary configuration of the shooting section 21. The shooting section 21 is made up of the side panel 41A, the side panel 41B, and the front panel 42, which are attached to a base member 43 having a box-like shape.

A camera unit 81 is disposed at the center of the front panel 42. The camera unit 81 is made up of a camera 91, a touch panel monitor 92, and a front strobe 93.

The camera 91 is, for example, a single-lens reflex camera, and is mounted inside the camera unit 81 with a lens being exposed to the outside. The camera 91 has an imaging element such as a CCD (charge coupled device) image sensor or a CMOS (complementary metal oxide semiconductor) image sensor, and captures an image of a user in the photographing space A1. A moving image captured by the camera 91 (hereinafter also referred to as a live-view image) is displayed on the touch panel monitor 92 in real time. A still image is captured by the camera 91 at predetermined timing such as when a user gives an instruction for photographing, and is then stored as a photographed image.

a focal distance of the camera 91, an imaging range (an angle of view of photographing, or an aspect ratio of an image generated as a result of the photographing), the number of the cameras 91 used for the photographing, a resolution, and so on, are variably controlled. The settings related thereto are comprised in conditions related to photographing (photographing conditions).

The front strobe 93 disposed above the camera 91 has one horizontally long elliptic light-emitting face and two vertically long elliptic light-emitting faces, where the light-emitting faces are made up of milky white acrylic plates. The front strobe 93 emits light in conjunction with the photographing by the camera 91 to illuminate the vicinity of the face of the user as a subject from the front of the user.

The touch panel monitor 92 disposed under the camera unit 81 is made up of a monitor such as an LCD (liquid crystal display) and a touch panel laminated thereon. The touch panel monitor 92 serves as a live-view monitor displaying the moving image captured by the camera 91, and it also serves to display various GUIs (graphical user interfaces) to receive a selection operation by the user. The touch panel monitor 92 displays the moving image (the live-view image) and the still image (the photographed image) captured by the camera 91.

An upper strobe 82 is disposed above the camera unit 81. The upper strobe 82 has a curved light-emitting surface directed to the user. The upper strobe 82 emits light in conjunction with the photographing by the camera 91 to illuminate the user from above.

A foot strobe 83 is disposed in the center of the base member 43 to illuminate the lower body and the feet of the user.

Spaces 84A and 84B are formed on the upper surfaces of the base member 43 on the left and right, with the upper surface of the foot strobe 83 located therebetween. The spaces 84A and 84B are used as a baggage rack for placing baggage etc. of the user taking a photograph. Although not shown, a speaker outputting sound such as guidance voice, BGM, and sound effects of the photographing process is also disposed on the front panel 42 near a ceiling, for example.

Illumination control values are variably controlled, where the illumination control values include a light emission amount and light emitting timing of the front strobe 93, the upper strobe 82, the foot strobe 83, a back right center strobe 101, a back right strobe 102, a back left strobe 103, and so on. Such illumination control values are comprised in the conditions related to photographing (photographing conditions).

### Configuration of Background Section

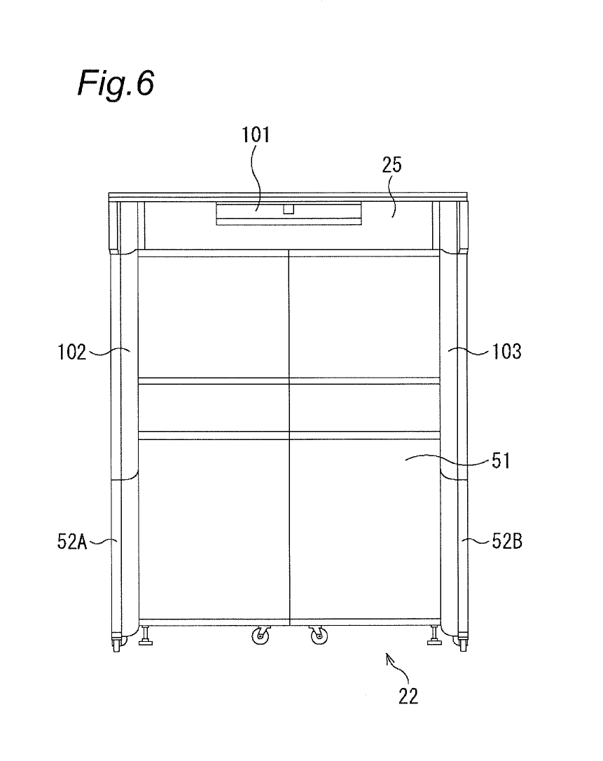

FIG. 6 is a side view showing an exemplary configuration of the photographing space A1 side of the background section 22.

As described above, the background curtain unit 25 is disposed on the upper side of the back panel 51. A back center strobe 101 is mounted to substantially the center of the background curtain unit 25, and it illuminates a user performing the photographing process in the photographing space A1 from the rear center.

A back right strobe 102 is mounted to the back panel 51 at a position close to the entrance/exit G1 side, and it illuminates the user performing the photographing process in the photographing space A1 from the right rear. A back left strobe 103 is mounted to the back face panel 51 at a position close to the entrance/exit G2 side, and it illuminates the user performing the photographing process in the photographing space A1 from the left rear.

### Configuration of Edit Unit

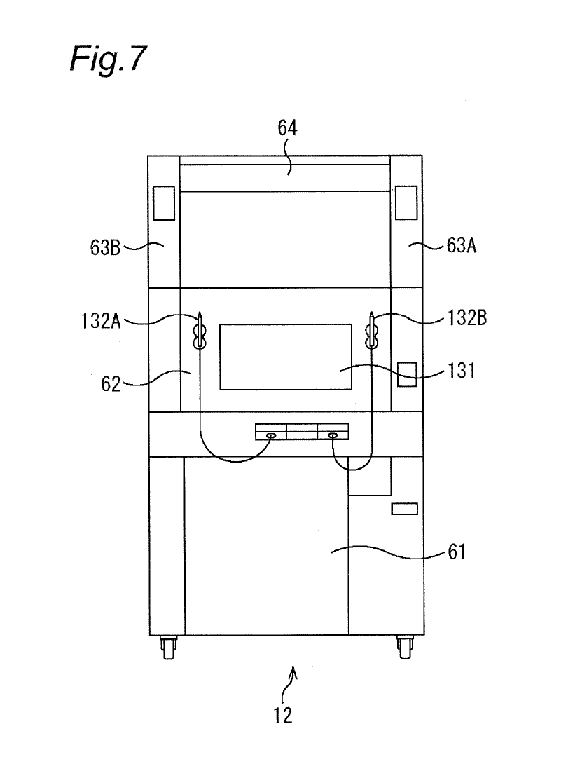

FIG. 7 is a front view showing an exemplary configuration of the edit unit 12 (on the edit space A2-1 side).

A tablet built-in monitor 131 is disposed on substantially the center of the slope 62. A stylus pen 132A and a stylus pen 132B are disposed on the left side and the right side of the tablet built-in monitor 131, respectively, sandwiching the tablet built-in monitor 131.

The tablet built-in monitor 131 is configured by a tablet which enables input of operation with the stylus pen 132A or 132B, and is disposed with a display being exposed outside. The tablet built-in monitor 131 displays an edit screen used for editing a photographed image, for example. When two users perform the edit operation at the same time with the two users facing the tablet built-in monitor 131, the stylus pen 132A is used by the user on the left side and the stylus pen 132B is used by the user on the right side.

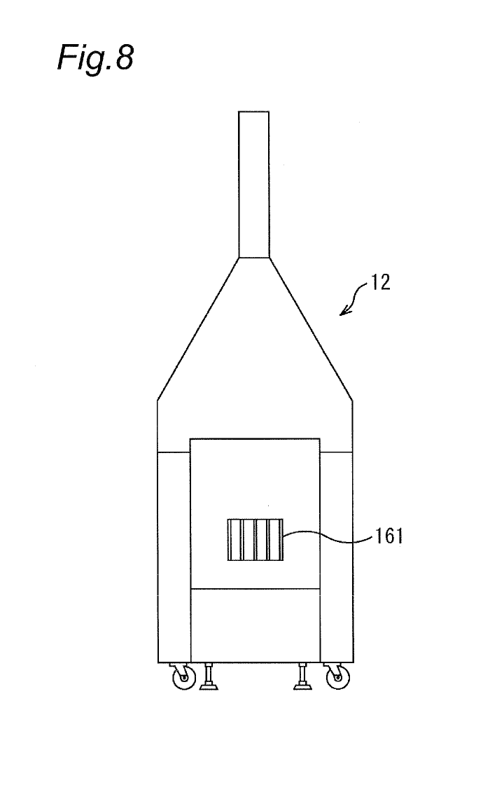

FIG. 8 is a side view showing an exemplary configuration of the right side of the edit unit 12.

A sticker sheet discharge port 161 is disposed at a lower portion of the right side of the edit unit 12. A printer is disposed inside the edit unit 12. An image of the user in the edit space A2-1 or an image of the user in the edit space A2-2 is printed on a sticker sheet, and the printed sticker sheet is discharged from the sticker sheet discharge port 161.

### Internal Configuration of Photo Sticker Creating Apparatus

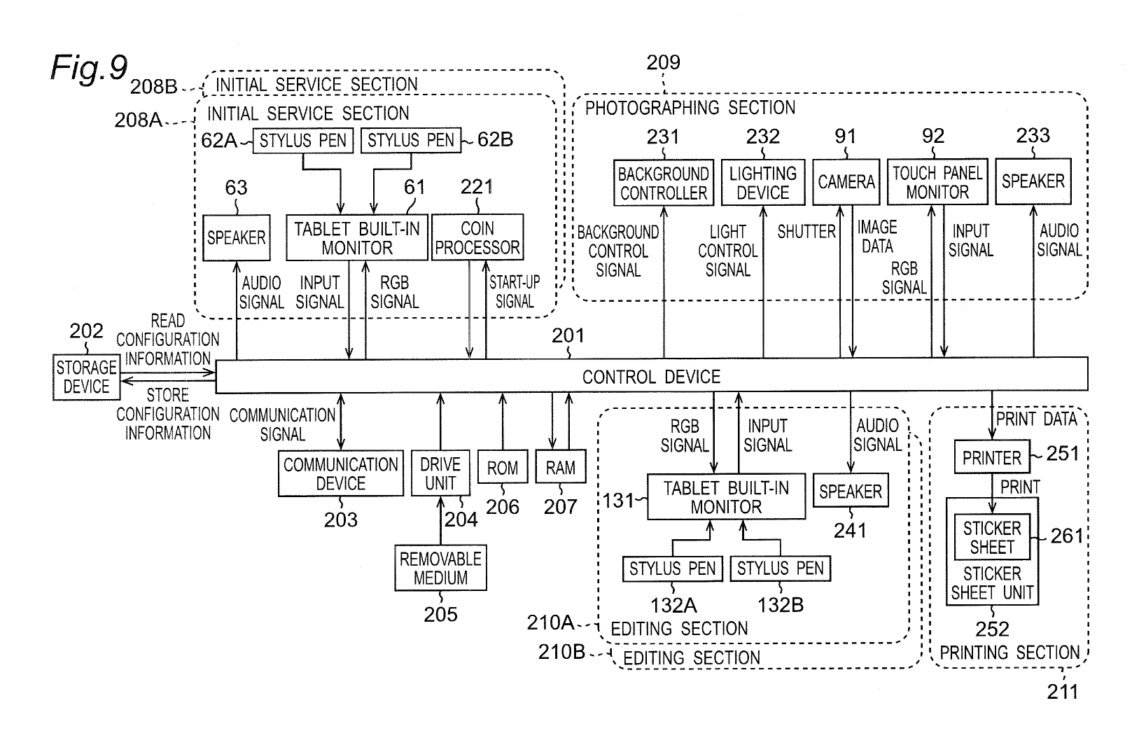

FIG. 9 is a block diagram of an exemplary internal configuration of the photo sticker creating apparatus 1. In FIG. 9, constituent elements same as those described above are denoted by the same reference numerals, and redundant descriptions will be omitted as needed.

A control device 201 is made up of a CPU (central processing unit) or the like, and executes programs stored in a ROM (read only memory) 206 and a storage device 202 to control overall operation of the photo sticker creating apparatus 1. The control device 201 is connected to the storage device 202, a communication device 203, a drive unit 204, the ROM 206, and a RAM (random access memory) 207. The control device 201 is also connected to constituent elements that are initial service sections 208A and 208B, a photographing section 209, editing sections 210A and 210B, and a printing section 211.

The storage device 202 is made up of a non-volatile storage medium such as a hard disk drive and a flash memory, and stores various pieces of setting information supplied from the control device 201. The information stored in the storage device 202 is read by the control device 201 as needed.

The communication device 203 is an interface for a network such as the Internet, and communicates with external apparatuses in accordance with the control by the control device 201. The communication device 203 transmits, for example, a photographed image and an edited image to a server. The images transmitted from the communication device 203 are assigned a predetermined storage area in the server and stored therein, and is displayed on or downloaded to a mobile terminal accessing the server.

The drive unit 204 is mounted, as needed, with a removable medium 205 that is made up of an optical disk or a semiconductor memory. Computer programs and data read by the drive unit 204 from the removable medium 205 are supplied to the control device 201, stored in the storage device 202, or installed.

The ROM 206 stores programs and data executed in the control device 201. The RAM 207 temporarily stores data and programs processed by the control device 201.

The initial service section 208A performs the initial service process for a user present in the initial service space A0-1. The initial service section 208A is made up of the tablet built-in monitor 71, the stylus pens 72A and 72B, the speaker 73, and a coin processor 221. The initial service section 208B has the same configuration as the initial service section 208A and performs the initial service process for a user present in the initial service space A0-2. Hereinafter, when the initial service sections 208A and 208B are not particularly distinguished from each other, they will simply be referred to as the initial service section 208.

The tablet built-in monitor 71 displays various selection screens in accordance with the control by the control device 201, and detects a user's operation to the selection screens. Input signals indicative of details of the user's operation are supplied to the control device 201 which performs various selection processes.

The coin processor 221 detects insertion of coins into the coin insert/return slot 74. When detecting that coins with a value of a certain amount, for example, 400 Japanese yen, are inserted, the coin processor 221 outputs a start-up signal indicative of the insertion, to the control device 201.

The photographing section 209 performs the photographing process for a user present in the photographing space A1. The photographing section 209 is made up of a background controller 231, a lighting device 232, the camera 91, the touch panel monitor 92, and a speaker 233.

The background controller 231 controls the background curtain unit 25 to raise and lower the background curtain in accordance with a background control signal supplied from the control device 201.

The lighting device 232 is each of strobes provided in the photographing space A1 and emits light in accordance with a light control signal supplied from the control device 201. In the photographing space A1, the strobe of the ceiling strobe unit 24 is provided as well as the front strobe 93, the upper strobe 82, the foot strobe 83 of the shooting section 21, the back center strobe 101, the back right strobe 102, and the back left strobe 103 of the background section 22.

The camera 91 takes a photograph in accordance with the shutter control of the control device 201 and outputs the image (image data) acquired from the photographing to the control device 201.

The editing section 210A performs the edit process for a user present in the edit space A2-1. The editing section 210A is made up of the tablet built-in monitor 131, the stylus pens 132A and 132B, and a speaker 241. The editing section 210B has the same configuration as the editing section 210A and performs the edit process for a user present in the edit space A2-2. Hereinafter when the editing sections 210A and 210B are not particularly distinguished from each other, they will simply be referred to as the editing section 210.

The tablet built-in monitor 131 displays an edit screen in accordance with the control by the control device 201, and detects a user's operation to the edit screen. Input signals indicative of details of user's operation are supplied to the control device 201 which performs editing of the photographed image to be edited.

The printing section 211 performs a printing process to provide a printed sticker sheet to a user present in the print waiting space A3. The printing section 211 includes a printer 251. The printer 251 is mounted with a sticker sheet unit 252.

The printer 251 prints the photographed image or the edited image on a sticker sheet 261 stored in the sticker sheet unit 252 based on print data supplied from the control device 201, and it discharges the printed sticker sheet to the sticker sheet discharge port 161.

### Configuration of Control Device

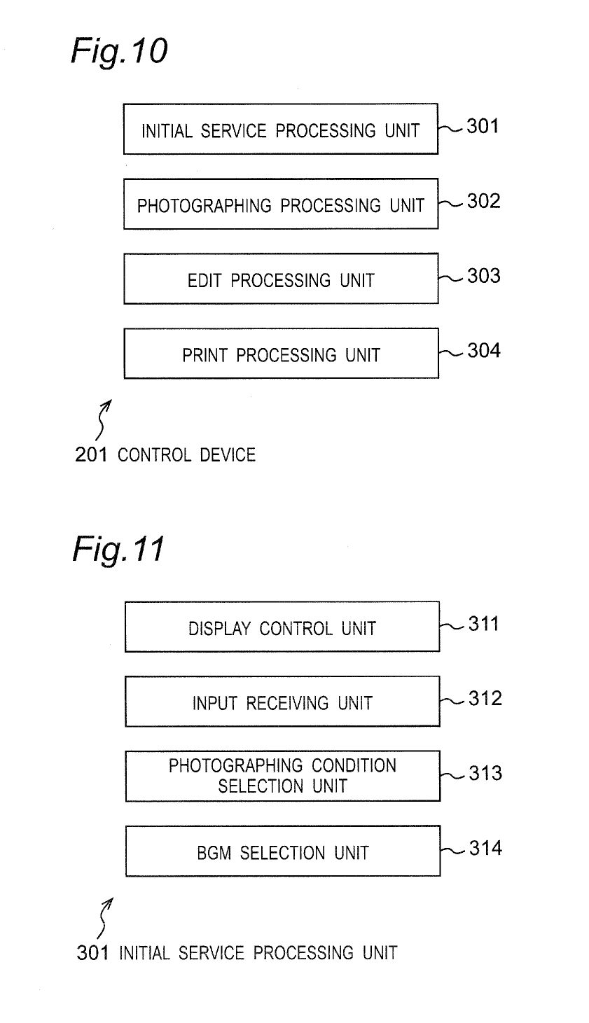

FIG. 10 is a block diagram of an exemplary functional configuration of the control device 201. At least a part of functional blocks shown in FIG. 10 are implemented by executing a predetermined program by the CPU in the control device 201.

The control device 201 implements an initial service processing unit 301, a photographing processing unit 302, an edit processing unit 303, and a print processing unit 304.

The initial service processing unit 301 controls each of elements of the initial service section 208 to perform the initial service process. The photographing processing unit 302 controls each of elements of the photographing section 209 to perform the photographing process. The edit processing unit 303 controls each of elements of the editing section 210 to perform the edit process. The print processing unit 304 controls the printer 251 of the printing section 211 to perform the printing process.

### Functional Configuration Example of Initial Service Processing Unit

With reference to FIG. 11, an exemplary functional configuration of the initial service processing unit 301 will be described below.

The initial service processing unit 301 is made up of a display control unit 311, an input receiving unit 312, a photographing condition selection unit 313, and a BGM selection unit 314.

The display control unit 311 controls display by the tablet built-in monitor 71 in the initial service section 208. For example, the display control unit 311 causes the tablet built-in monitor 71 to display a selection screen for selecting a photographing condition that is a condition related to photographing and a selection screen for selecting music as BGM to be played in the photographing space.

The input receiving unit 312 receives operation input from a user using the stylus pen 72A and 72B to the tablet built-in monitor 71. For example, the input receiving unit 312 receives the operation input of selection to various selection screens displayed on the tablet built-in monitor 71.

The photographing condition selection unit 313 chooses a photographing condition or selects one of a plurality of predetermined photographing conditions to determine the photographing condition, based on a result of the receiving by the input receiving unit 312 for a selection screen allowing a user to select a photographing condition.

The photographing conditions include a background image that is a background of a subject in the photographed image acquired from the photographing performed in the photographing space, a category into which the background image is categorized, an image process applied to the photographed image, and a picture condition (quality) of the subject determined by illumination control or the like at the time of photographing. The photographing conditions also include parameter values such as a focal distance of the camera 91, an imaging range (an angle of view of photographing, or an aspect ratio of an image generated as a result of the photographing), and a swing angle (a tilt angle of the camera 91), the number of the cameras 91 used for the photographing, and resolution. The photographing conditions also include illumination control values such as a light, emission amount of the strobe 82, light-emitting timing, and the disposition positions of the strobes actually allowed to emit light out of the strobe 82, etc. The photographing conditions further include parameter values indicative of forms of photographing such as collage photographing, collage photographing using filtering, pin photographing (photographing in which a plurality of users are photographed as subjects and generating an image for each user from the photographed image) , and normal photographing, as well as a date of photographing, a time of photographing, etc.

The BGM selection unit 314 selects a piece of BGM, or selects some of a plurality of predetermined pieces of BGM to determine the BGM based on a result of the receiving by the input receiving unit 312 for the selection screen allowing the user to select BGM.

### Exemplary Functional Configuration of Photographing Processing Unit

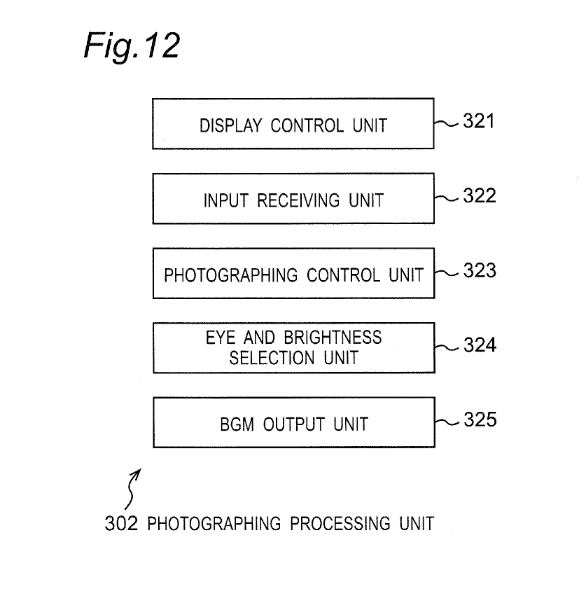

With reference to FIG. 12, an exemplary functional configuration of the photographing processing unit 302 will be described below.

The photographing processing unit 302 is made up of a display control unit 321, an input receiving unit 322, a photographing processing unit 323, an eye and brightness selection unit 324, and a BGM output unit 325.

The display control unit 321 controls the display of the touch panel monitor 92 in the shooting section 209.

The input receiving unit 322 receives operation input from a user to the touch panel monitor 92.

The photographing control unit 323 controls the camera 91 to photograph the user as a subject multiple times and acquires a plurality of photographed images.

The eye and brightness selection unit 324 selects the eye size and the skin brightness of the subject (user) in the photographed image based on the operation input from the user to the touch panel monitor 92.

The BGM output unit 325 serves to play (reproduce) various pieces of music stored in the storage device 202, for example. The BGM output unit 325 outputs from the speaker 233 music as a BGM played in the photographing space, the BGM being selected and determined by the BGM selection unit 314.

### Operation of Photo Sticker Creating Apparatus

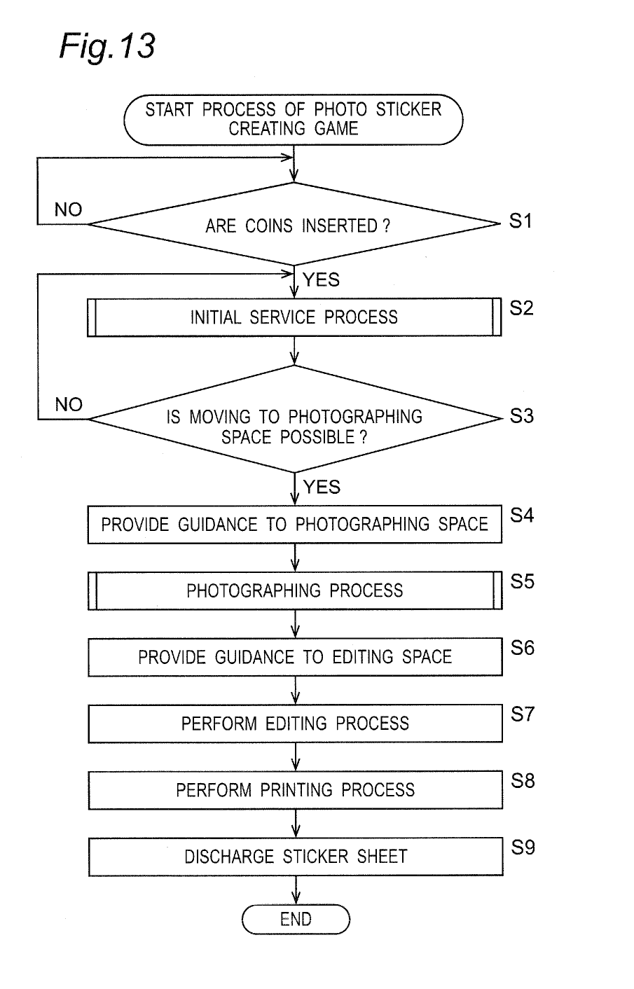

With reference to a flowchart of FIG. 13, the operation of the photo sticker creating apparatus 1 providing the photo sticker creating game will be described below.

At Step S1, the initial service processing unit 301 determines whether coins with a value of a predetermined amount are inserted, based on the start-up signal supplied from the coin processor 221, and waits until it is determined that the coins are inserted.

If it is determined that the coins are inserted at Step S1, the initial service processing unit 301 controls the initial service section 208 corresponding to an initial space out of the initial service spaces A0-1 and A0-2 in which the coins are inserted, to perform the initial service process in which various settings are performed by allowing a user to select the photographing conditions as described above and to select BGM to be played in the photographing space.

At Step S3, the initial service processing unit 301 determines whether the user performing the initial service operation can move to the photographing space A1. More precisely, the initial service processing unit 301 determines whether the photographing space A1 is being used based on a progress status of the photographing operation by users of a preceding group. If it is determined that the photographing space A1 is being used and thus the user performing the initial service operation cannot move to the photographing space A1, the process returns to Step S2 to continue the initial service process by providing guidance on the photographing process, for example.

If it is determined at Step S3 that the photographing space A1 is not being used and thus the user can move to the photographing space A1, the process proceeds to Step S4 and the initial service processing unit 301 guides the user present in the initial service space A0-1 or the initial service space A0-2 to move to the photographing space A1. The guiding for the move to the photographing space A1 is performed by causing the tablet built-in monitor 71 of the initial service section 208 to display a guide screen or by causing the speaker 73 to output sound.

At Step S5, the photographing processing unit 302 controls the shooting section 209 to perform the photographing process by causing the touch panel monitor 92 to perform the live-view display of the moving image of the subject captured by the camera 91 and photographing the user as the subject in the photographing space A1 to acquire the photographed image.

In the photographing process, the photographing is performed seven times for example, and seven photographed images are acquired as a result of the photographing. The number of times of photographing is obviously not limited to seven.

At Step S6, the photographing processing unit 302 guides the user present in the photographing space A1 to move to the edit space A2-1 or the edit space A2-2. The guiding for the move to the edit space A2-1 or the edit space A2-2 is performed by causing the touch panel monitor 92 of the shooting section 209 to display a guide screen or by causing the speaker 233 to output sound.

At Step S7, the edit processing unit 303 controls the editing section 210 corresponding to an edit space out of the edit space A2-1 and the edit space A2-2 which is defined as the destination of the user who finished the photographing process, so as to perform the edit process by allowing the user to perform the graffiti edit to the photographed image acquired from the photographing process to generate the edited image subjected to the graffiti edit. The edit process also includes determining, in accordance with selection by the user, a sticker layout representative of an arrangement of the edited images or the photographed images to be printed on a sticker sheet and a design (including color and graphics) on a region other than the region on which the edited images or the photographed images are to be arranged.

The edited image or the photographed image is transmitted via the external server to a portable terminal such as a portable telephone owned by a user. For this purpose, in the edit process, the user is allowed to input an e-mail address of the portable terminal necessary for the portable terminal to receive an e-mail describing a URL required for accessing the server.

As a result, the server transmits an e-mail describing a URL required for the portable device to access the server to the e-mail address input by the user the e-mail. When the portable terminal owned by the user accesses the server through the network such as the Internet based on such URL, the edited image or the photographed image transmitted to the server is provided to the portable terminal.

At Step S8, the print processing unit 304 performs (starts) the printing process to output the photographed image acquired from the photographing process or the edited image acquired from the edit process as a print image to the printer 251 for printing it on a sticker sheet.

When the printing is completed, the printer 251 discharges, at Step 9, the sticker sheet with the printed image to the sticker sheet discharge port 161 and then the process completes. In this case, the edit processing unit 303 causes the tablet built-in monitor 131 to display that the printing is completed, for the user finishing the edit process in the edit space A2-1 or the edit space A2-2, thereby guiding the user to move to the print waiting space A3. The guiding for the move to the print waiting space A3 may be performed by causing the speaker 241 to output sound.

### Flow of First Service Process

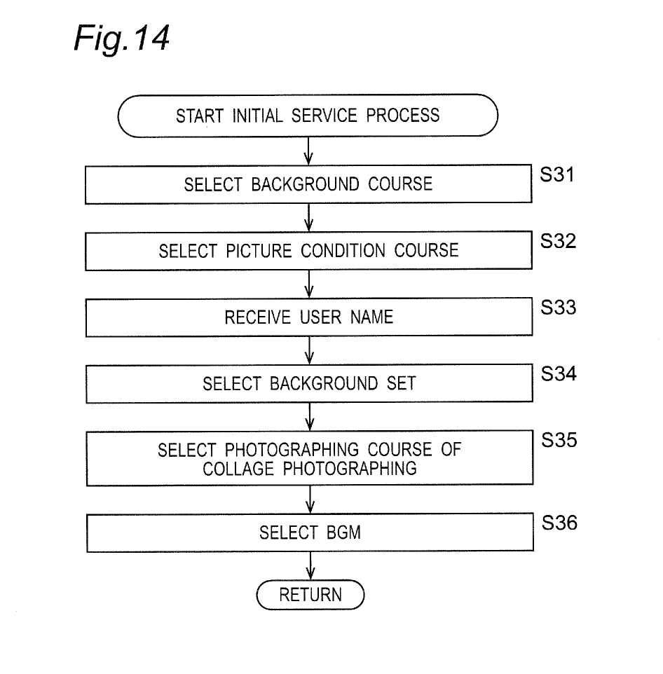

With reference to a flowchart of FIG. 14, a flow of the initial service process of Step S2 in the photo sticker creating game will be described below.

When the initial service process is started, the initial service processing unit 301 controls the tablet built-in monitor 71, the speaker 73, and so on to output images and sounds introducing a flow of the photo sticker creating game, thereby proving guidance for the photo sticker creating game to a user.

At Step S31, the display control unit 311 causes the tablet built-in monitor 71 to display a background course selection screen and the input receiving unit 312 receives an instruction from the user using the stylus pens 72A and 723, thereby allowing the user to select a background course. Based on a result of the receiving by the input receiving unit 312, the photographing condition selection unit 313 selects one of a plurality of background courses as one of the photographing conditions. The background course selection screen is a screen used for selecting a background course determining a type of background images composited with the photographed images. The background courses include, for example, as types of background images, an “enjoy shot” course providing background images finishing the photographed images composited with the background images with a cheerful and amusing atmosphere, and a “beauty shot” course providing background images finishing the photographed images composited with the background images with a calm and somewhat mature atmosphere.

At Step S32, the display control unit 311 causes the tablet built-in monitor 71 to display a picture condition course selection screen and the input receiving unit 312 receives an instruction from the user using the stylus pens 72A and 72B, thereby allowing the user to select a picture condition course. Based on a result of the receiving by the input receiving unit 312, the photographing condition selection unit 313 selects one picture condition course, as one of photographing conditions, out of a plurality of picture condition courses. The picture condition course selection screen is a screen used for selecting the picture condition course that determines the picture condition of the subject in the photographed image.

At Step S33, the display control unit 311 causes the tablet built-in monitor 71 to display a name entry screen and the input receiving unit 312 receives an instruction from the user using the stylus pens 72A and 72B, thereby allowing the users to enter the respective names. The name entry screen is a screen used by the users for entering their names.

At Step S34, the display control unit 311 causes the tablet built-in monitor 71 to display a background set selection screen and the input receiving unit 312 receives an instruction from the user using the stylus pens 72A and 72B, thereby allowing the user to select a background set. Based on a result of the receiving by the input receiving unit 312, the photographing condition selection unit 313 selects a background set, as one of photographing conditions, out of a plurality of background sets.

A background set is configured as one set of a plurality of background images unified under a predetermined theme.

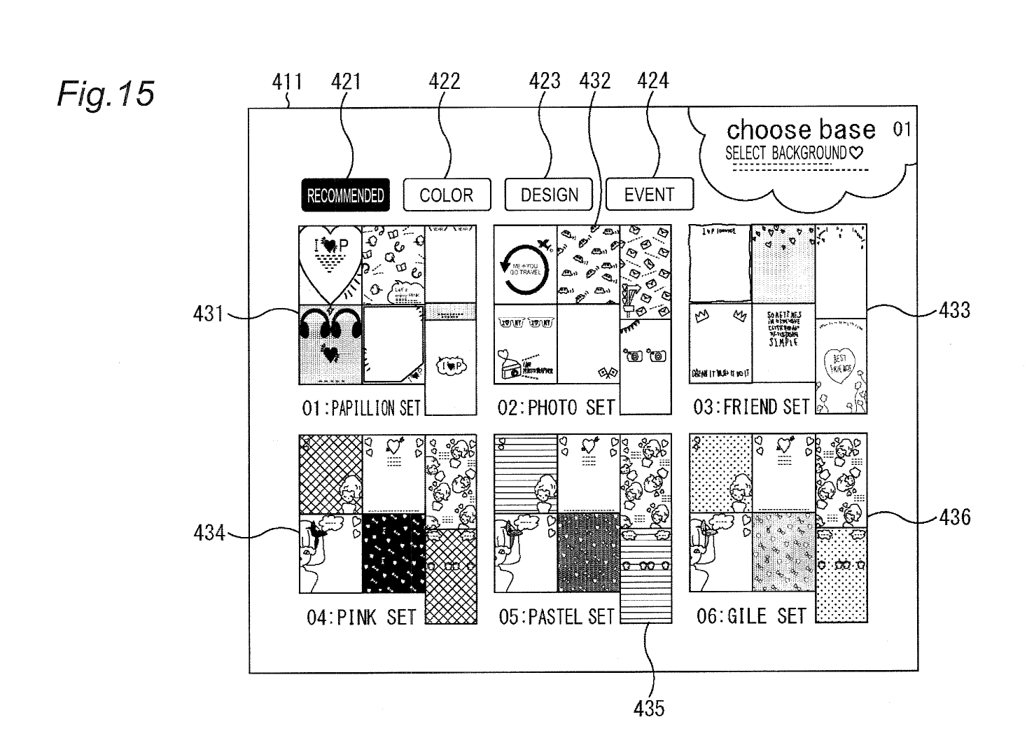

FIG. 15 is a diagram showing an example of the background set selection screen displayed for selecting a background set.

As depicted in FIG. 15, the background sets displayed on the background set selection screen 411 are switched by buttons 421 to 424 corresponding to categories such as “RECOMMENDED”, “COLOR”, “DESIGN”, and “EVENT”, respectively. In the example of FIG. 15, the “RECOMMENDED” button 421 is selected. On the background set selection screen 411 with the “RECOMMENDED” button 421 selected, six background sets 431 to 436 are displayed by themes.

Although not shown, if the “EVENT” button 424 is selected, the background sets under the theme of seasonal events or memorial days such as a birthday are displayed on the background set selection screen 411.

The categories of the background sets such as “RECOMMENDED”, “COLOR”, “DESIGN”, and “EVENT” may be switched and displayed by widgets (parts of GUI) such as tabs and radio buttons rather than being displayed in accordance with the buttons 421 to 422.

Returning to the flowchart of FIG. 14, at Step S35, the display control unit 311 causes the tablet built-in monitor 71 to display a collage photographing course selection screen, and the input receiving unit 312 receives an instruction from the user using the stylus pens 72A and 72B, thereby allowing the user to select a photographing course of the collage photographing. Based on a result of the receiving by the input receiving unit 312, the photographing condition selection unit 313 selects one photographing course out of multiple photographing courses of the collage photographing as one of the photographing conditions.

The collage photographing is performed as the seventh photographing among the seven times of photographing performed in the photographing process, and is the photographing for acquiring a collage photographed image made up of a seventh photographed image acquired from this photographing arranged, along with a predetermined number of photographed images out of six photographed images acquired from the first photographing to the sixth photographing, on a design image with a predetermined design. The collage photographing course selection screen is a screen used for the course selection f determining whether the collage photographed image is subjected to filtering (a process for changing brightness, transparency, and a color tone of an image).

At Step S36, the display control unit 311 causes the tablet built-in monitor 71 to display a BGM selection screen and the input receiving unit 312 receives an instruction from the user using the stylus pens 72A and 72B, thereby allowing the user to select BGM to be played in the photographing space. Based on a result of the receiving by the input receiving unit 312, the BGM selection unit 314 selects the BGM to be played in the photographing space.

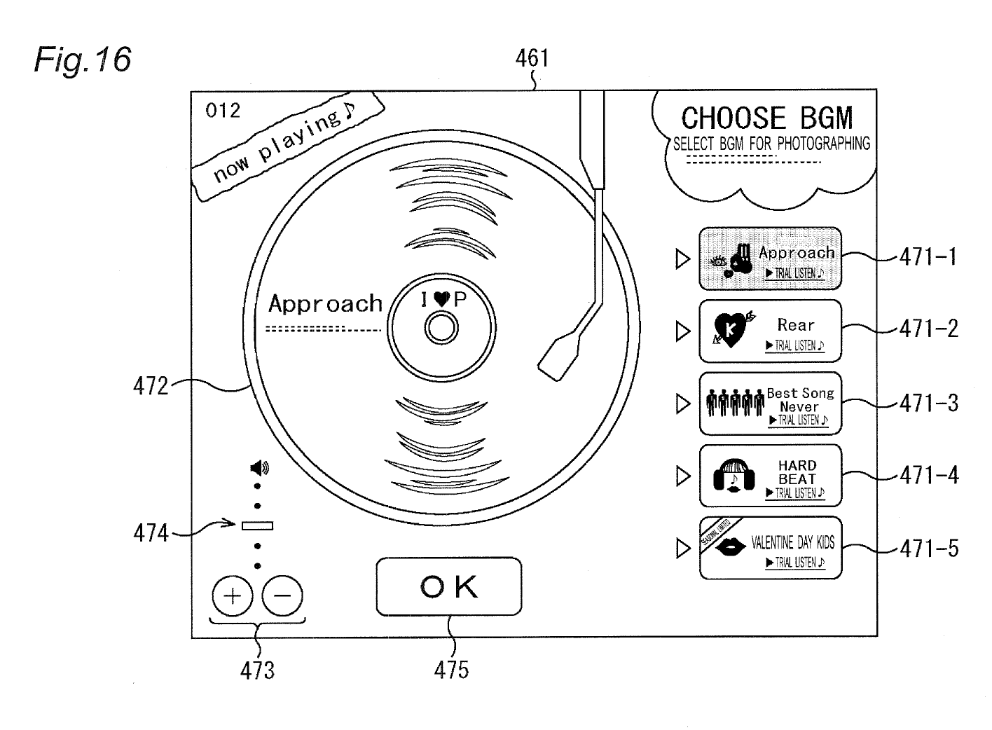

FIG. 16 is a diagram showing an example of a BGM selection screen displayed for selecting BGM to be played in the photographing space.

As depicted in FIG. 16, music buttons 471-1 to 471-5 are disposed in a region on the right side on a BGM selection screen 461, the music buttons 471-1 to 471-5 being indicative of five pieces of music each of which is a candidate of music for BGM. When one of the music buttons 471-1 to 471-5 is selected, music (music title) corresponding to the selected music button is displayed in a selected music displaying region 472 in imitation of a phonograph record disposed in a large region on the left side of the music buttons 471-1 to 471-5. In this case, the BGM selection unit 314 outputs the music corresponding to the selected music button via the speaker 73 of the initial service section 208.

More precisely, if the music button 471-1 is selected, a music title of the corresponding music “Approach” is displayed on the selected music displaying region 472 and the music “Approach” is output from the speaker 73. If the music button 471-2 is selected, a music title of the corresponding music “Rear” is displayed on the selected music displaying region 472 and the music “Rear” is output from the speaker 73.

If the music button 471-3 is selected, a music title of the corresponding music “Best Song Never” is displayed on the selected music displaying region 472 and the music “Best Song Never” is output from the speaker 73. If the music button 471-4 is selected, a music title of the corresponding music “HARD BEAT” is displayed on the selected music displaying region 472 and the music “HARD BEAT” is output from the speaker 73.

If the music button 471-5 is selected, a music title of the corresponding music “Valentine day Kids” is displayed on the selected music displaying region 472 and the music “Valentine day Kids” is output from the speaker 73.

The music corresponding to the music button 471-5 is a seasonally limited music corresponding to the current season. For example, for the music corresponding to the music button 471-5, music under the theme of spring is prepared from February 15 to May 31. Music under the theme of summer is prepared from January 1 to September 30. Music under the theme of Halloween is prepared from October 1 to November 30. Music under the theme of Christmas is prepared from December 1 to December 25. Music under the theme of the New Year is prepared from December 26 to January 14. Music under the theme of Valentine's Day is prepared from January 15 to February 14.

FIG. 16 depicts a default state when the BGM selection screen 461 is first displayed and, in this state, the music button 471-1 is selected and the music title “Approach” corresponding to the music button 471-1 is displayed on the selected music displaying region 472. The music with the music title of “Approach” is output from the speaker 73.

In particular, in the default state of the BGM selection screen 461, the music button 471-1 is displayed in a color different from the other music buttons so as to notify that the music button 471-1 has been selected, allowing the user to recognize that which music is selected and is being output and to recognize that other music can be output by selecting other music buttons.

On the BGM selection screen 461, in a region on the lower left side, sound volume adjustment buttons 473 for adjusting a sound volume of the music output from the speaker 73, and a sound volume indicator 474 indicative of a level of the sound volume of the music output from the speaker 73 are disposed.

On the BGM selection screen 461, in a region under the selected music displaying region 472, an OK button 475 for determining the music displayed in the selected music displaying region 472 as the BGM played in the photographing space is disposed.

Therefore, the user can select any of the music buttons 471-1 to 471-5, listen to music corresponding to the selected music button output from the speaker 73 on trial, and press the OK button 475 to determine the music as BGM to be played in the photographing space. The user can repeatedly select any of the music buttons 471-1 to 471-5 to listen to the pieces of music respectively corresponding to the music buttons on trial before pressing the OK button, provided it is within a preset period of time (until a countdown indicator displayed on the upper left of the BGM selection screen 461 becomes zero).

When one of the music buttons 471-1 to 471-5 is selected and the OK button 475 is pressed on the BGM selection screen 461 in this way, the process returns to Step S2 of FIG. 13 and the subsequent process steps are performed.

At least one of the music buttons 471-1 to 471-5 on the BGM selection screen 461 is configured to be changed to a music button for music corresponding to a photographing condition selected by the photographing condition selection unit 313.

More precisely, the music corresponding to the music button 471-4 out of the music buttons 471-1 to 471-5 is changed to the music corresponding to the background set that is one of the photographing conditions.

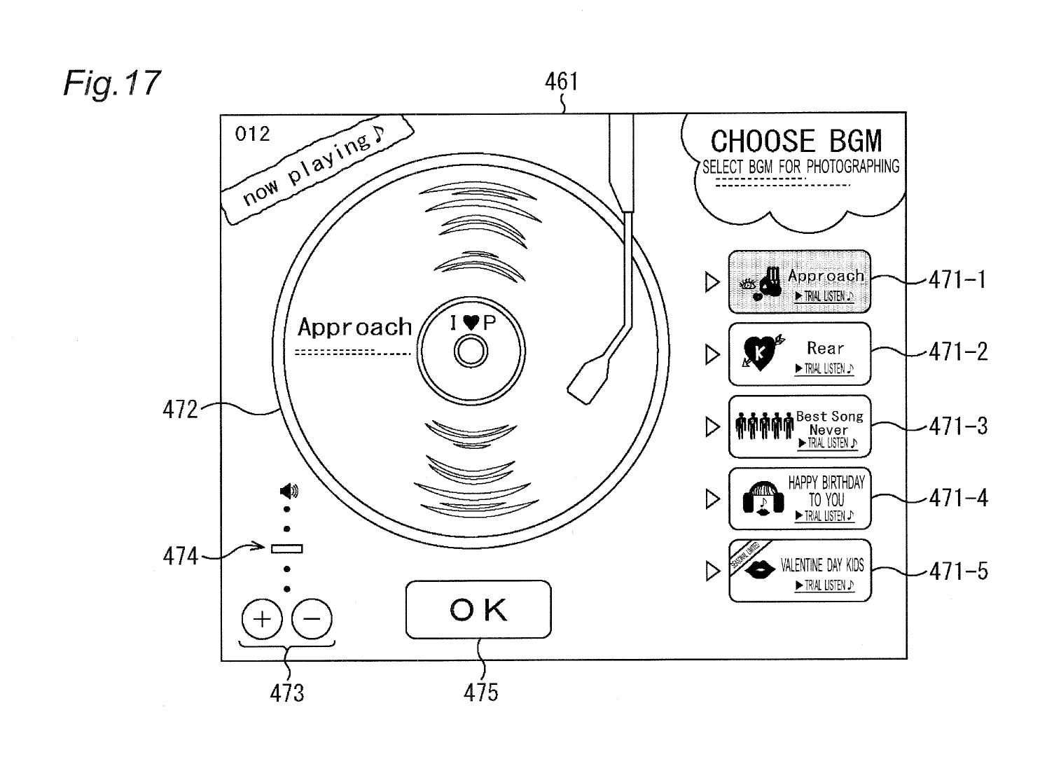

For example, when the “EVENT” button is selected on the background set selection screen 411 and when a background set under the theme of a birthday is selected, as depicted in FIG. 17, the music corresponding to the music button 471-4 is changed from the music of “HARD BEAT” to music of “Happy Birthday to You” corresponding to the background set (the theme of the background set) that is one of the photographing conditions, namely, corresponding to the birthday.

Not only one piece of music corresponding to the music button 471-4, but also some pieces of music or all pieces of music corresponding to some or all of the music buttons 471-1 to 471-5 may be changed.

The music changed depending on a photographing condition may be music corresponding to one of the buttons 421 to 424 corresponding to the categories selected on the background set selection screen 411. More precisely, if the “EVENT” button 424 is selected on the background set selection screen 411, at least one of plurality of pieces of music corresponding to the respective music buttons 471-1 to 471-5 may be changed to music suiting for a season which includes the photographing date. For example, if the photographing date is December 20, at least one of the music buttons 471-1 to 471-5 is changed to music under the theme of Christmas regardless of which is selected among the background sets displayed by selecting the “EVENT” button 424 on the background set selection screen 411.

As described above, at least one of the plurality of pieces of music corresponding to the music buttons 471-1 to 471-5 is changed, on the BGM selection screen 461, to music corresponding to the theme or the category of the background set that is one of the photographing conditions. Therefore, the music corresponding to the photographing condition (the background set) selected by a user in accordance with a feeling at. the time is presented as an option of the BGM to be played in the photographing space. Therefore, the user does not take much time for searching for BGM matching the feeling at the time, and effort of the user for selecting BGM can be reduced.

Although the background set is selected as one of the photographing conditions in the above description, the background images to be composited with the six photographed images maybe individually selected. In this case, at least one of the plurality of pieces of music corresponding to the music buttons 471-1 to 471-5 may be changed to music corresponding the category of the background images or may be changed, on the BGM selection screen 461, to music corresponding to the color (more precisely, hue, luminance, chrominance, and so on) included most in the six selected background images.

For example, if a primary color is used in many parts in the six selected background images, at least one of the plurality of pieces of music corresponding to the music buttons 471-1 to 471-5 is changed to up-tempo music or is changed to music having a title (music title) including the name of the color used in many parts.

Among the background images described above, some background images may be configured to include a foreground image such as a stamp image and a frame image composited on the foreground of a subject in addition to an image composited on the background of the subject in the photographed image.

Therefore, at least one of the plurality of pieces of music corresponding to the music buttons 471-1 to 471-5 may be changed, on the BGM selection screen 461, to music corresponding to a design or an atmosphere of the foreground image included in the selected background image.

Although, in the above description, at least one of the plurality of pieces of music corresponding to the music buttons 471-1 to 471-5 is changed to music corresponding to the background set or the background images as a photographing condition, the music may be changed to music corresponding to another photographing condition such as the background course, the picture condition course, or the photographing course of the collage photographing, or may be changed to music corresponding to a combination of at least two of these photographing conditions. At least one of the plurality of pieces of music corresponding to the music buttons 471-1 to 471-5 may be changed to music corresponding to a photographing condition (such as the parameter values such as a focal distance of the camera 91, an imaging range (an angle of view of photographing or an aspect ratio of an image generated as a result of photographing), a swing angle of the camera 91, the number of the cameras 91 used for photographing, and resolution, the illumination control values such as a light emission amount of the strobe 82, and so on, and the disposition positions of the strobes actually allowed to emit light, parameter values indicative of forms of photographing, a date of photographing, and a time of photographing).

For example, when the “enjoy shot” course is selected as a background course, background images finishing the photographed images with a cheerful and amusing atmosphere are composited in the photographing process and, therefore, at least one of the plurality of pieces of music corresponding to the music buttons 471-1 to 471-5 is changed to up-tempo music matching the atmosphere.

The storage device 202 may store the numbers of times of the selection of the respective pieces of music corresponding to the music buttons 471-1 to 471-5 displayed on the BGM selection screen 461. In this case, the top five most frequently selected pieces of music may be defined, in this order, as pieces of music corresponding to the music buttons 471-1 to 471-5. Alternatively, for example, only the top two most frequently selected pieces of music may be defined as the pieces of music corresponding to the music buttons 471-1 and 471-2.

The top five pieces of music of the daily, weekly, or monthly music chart may be applied to the pieces of music corresponding to the music buttons 471-1 to 471-5 displayed on the BGM selection screen 461.

A maximum allowable times of the operations are determined in advance in the initial service process described above for respective steps of the selection of the background course (Step S31), the selection of the picture condition course (Step S32), the name entry (Step S33), the selection of the background set (Step S34), the selection of the photographing course of the collage photographing (Step S35), and the selection of the BGM (Step S36). However, a time for allowing the user to select BGM at Step S36 may be changed depending on the time taken for the operations at steps S31 to S35.

More precisely, if every the times taken for the operations at steps S31 to S35 is shorter than the respective maximum allowable times, the surplus times occurred in the steps are assigned to the process of Step S36 so as to extend the time for allowing the user to select BGM.

In this case, a message such as “you can select BGM any number of times within the time!” may be displayed on the BGM selection screen 461 to encourage the user to carefully select BGM. In addition, if a sufficient remaining time exits when the OK button 475 is pressed, a message such as “are you sure to select this BGM?” may be displayed to prompt the user to check whether the selection of the BGM is confirmed.

As a result, the user can certainty select desired BGM with a margin of time.

Even if the times taken for the operations at steps S31 to S35 are shorter than the respective maximum allowable times, the maximum allowable time of the operation at Step S36 may not be changed to increase a turnover rate of the photo sticker creating game.

If the user does not select a photographing condition within the maximum allowable time (if the time expires) at every step of selection of a photographing condition such as the background course, the picture condition course, the background set, and the photographing course of the collage photographing in the initial service process, predetermined one of a plurality of photographing conditions may be selected as a photographing condition. Similarly, if the time expires at the. step of selection of BGM, predetermined one of a plurality of pieces of music may be selected as BGM.

Allowing the user to select BGM at the last stage of the initial service process can prevent the user from forgetting that the BGM played in the subsequent photographing process is the one selected by the user themselves.

### Flow of Photographing Process

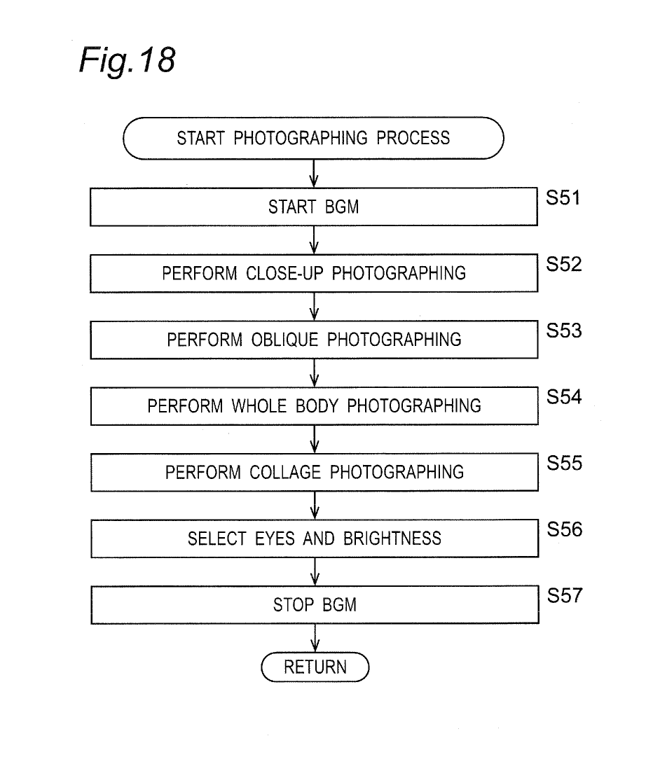

With reference to a flowchart of FIG. 18, a flow of the photographing process at Step S5 in a series of the process steps of the photo sticker creating game described above will be described below.

When the photographing process is started, the display control unit 321 of the photographing processing unit 302 causes the touch panel monitor 92 to display a message such as “please touch!”. When the input receiving unit 322 receives an instruction from the user the BGM output unit 325 starts, at Step S51, output of the BGM (music) selected by the user in the initial service process via the speaker 233. At this point, the touch panel monitor 92 displays the title of the music selected by the user, in other words, the title of the music output from the speaker 233.

A reproduction start position of the output music is a chorus section that is a most exciting and well-known portion of the music.

Instead of starting the output of the BGM in accordance with the user's operation to the touch panel monitor 92, the output of the BGM may be started when a certain time has elapsed after the detection of the movement of the user to the photographing space.

Subsequently, the photographing processing unit 302 controls the touch panel monitor 92, the speaker 233, and so on to provide guidance for close-up photographing, that is a photographing of an image in which the face and the upper body of the user standing straight is directly photographed straight, and then performs the close-up photographing at Step S52.

More precisely, the photographing control unit 323 controls the camera 91 to start capturing an image covering a range from the top of the head to near the waist of the user and causes the touch panel monitor 92 to display a moving image (live-view image) captured by the camera 91 (performs the live-view display). The photographing control unit 323 then displays a countdown indicator on the touch panel monitor 92 to notify the user of photographing timing. When the photographing timing comes, the photographing control unit 323 controls the camera 91 to perform the photographing and acquires a close-up photographed image that is a still image in which the face and the upper body of the user standing straight is directly photographed straight. The acquired close-up photographed image is displayed as a photographed result on the touch panel monitor 92.

After the close-up photographing is performed twice at Step S52, the photographing processing unit 302 controls the touch panel monitor 92, the speaker 233, and so on to provide guidance for oblique photographing, that is a photographing of an image in which the face and the upper body of the user standing straight are photographed obliquely to the left or right, and then performs the oblique photographing at Step S53.

Details of the oblique photographing are basically the same as the close-up photographing and will be omitted. An obliquely photographed image acquired from the oblique photographing is a still image in which the face and the upper body of the user standing straight are photographed obliquely to the left or right.

After the oblique photographing is performed twice at Step S53, the photographing processing unit 302 controls the touch panel monitor 92, the speaker 233, and so on to provide a guidance for whole body photographing, that is a photographing of an image in which the whole body of the user standing straight is photographed, and then performs the whole body photographing at Step S54.

Details of the whole body photographing are also basically the same as the close-up photographing and will be omitted. A whole body photographed image acquired from the whole body photographing is a still image in which the whole body of the user standing straight is photographed.

In this manner, the first photographing to the sixth photographing are performed out of the seven times of the photographing. The music selected in the initial service process is output as the BGM via the speaker 233 also during this period.

In the example of the first photographing to the sixth photographing described above, the photographing is performed while changing the imaging range (an angle of view of photographing or an aspect ratio of an image) that is one of the photographing conditions. The BGM output unit 325 may change the BGM in conjunction with the change in the imaging range. For example, the BGM output unit 325 may change the BGM for each time of photographing. For example, the BGM output unit 325 may output the music at a slow tempo during the close-up photographing, may output the music at a medium tempo during the oblique photographing, and may output the music at an up-tempo during the whole body photographing. In this case, the music may be output by using versions with different tempos of a single music, or by using multiple pieces of music different from each other. During the whole body photographing, the tempo may be changed depending on which camera is used out of the plurality of cameras 91. Instead, the music may be changed. Alternatively, the tempo of the music may be changed depending on the number of the cameras 91 used during the first photographing to the sixth photographing. Instead, the music may be changed.

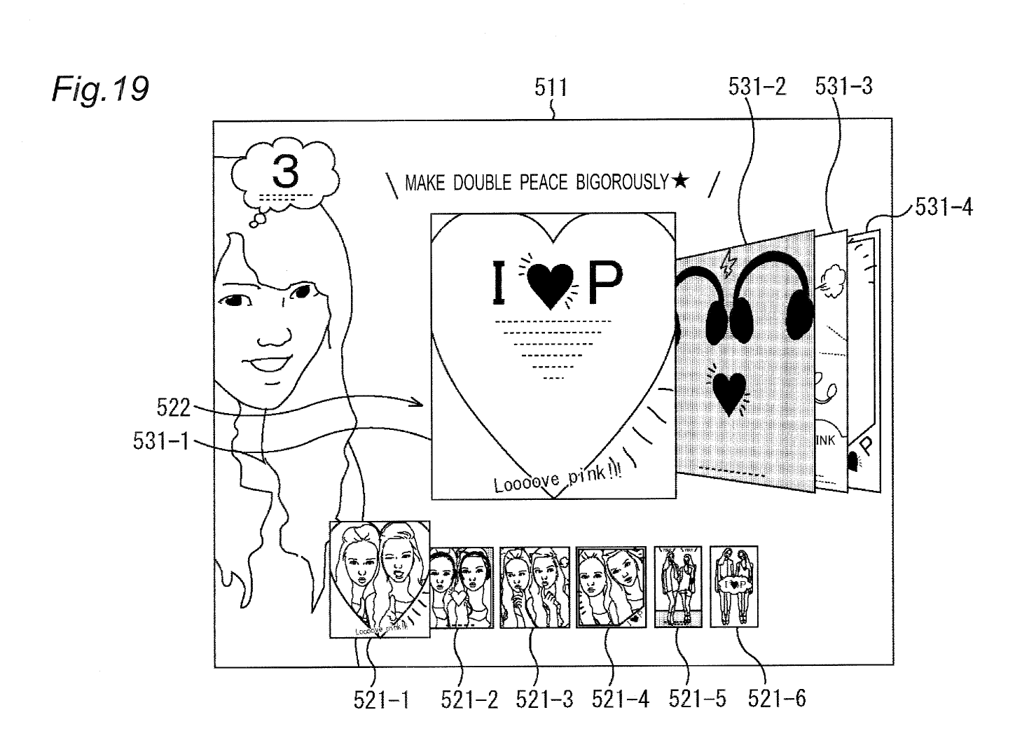

With reference to FIG. 19, description will be made of an example of a photographing screen displayed on the touch panel monitor 92 at the time of the first photographing to the sixth photographing.

As depicted in FIG. 19, in a region on the lower side of the photographing screen 511, six sample images 521-1 to 521-6 are displayed that are acquired by compositing six respective model images photographed by using models as subjects on the six background images included in the background set selected in the initial service process. In the example of FIG. 19, the six background images making up the background set 431 selected in the initial service process are composited with the respective sample images 521-1 to 521-6, and the composited images are displayed.

The background images composited with the respective sample images 521-1 to 521-6 are composited with respective photographed images acquired from the first photographing to the sixth photographing. Therefore, for example, the background image composited with the sample image 521-1 is composited with the close-up photographed image acquired from the first photographing; the background image composited with the sample image 521-3 is composited with the obliquely photographed image acquired from the third photographing; and the background image composited with the sample image 521-5 is composited with the whole body photographed image acquired from the fifth photographing.

When n-th (n is an integer from one to six) photographing is performed, a sample image 521-n is displayed larger on the photographing screen 511, and the live-view image captured by the camera 91 is displayed on the background image composited with the sample image 521-n in a live-view image display region 522 displayed at substantially the center of the photographing screen 511.

In the example of FIG. 19, the sample image 521-1 is displayed larger, and a live-view image (the subjects are not depicted) is composited and displayed in the live-view image display region 522 with the background image 531-1 composited with the sample image 521-1. Therefore, FIG. 19 depicts an example of the photographing screen 511 when the first photographing is performed. On the right side of the live-view image display region 522 on the photographing screen 511, a background image 531-2 composited with the sample image 521-2, a background image 531-3 composited with the sample image 521-3, and a background image 531-4 composited with the sample image 521-4 are displayed such that these images are three-dimensionally piled up.

After the first photographing, the closed-up photographed image acquired as a result of the photographing is displayed on the left side of the live-view image display region 522 on the photographing screen 511 symmetrically to the background images 531-2 to 531-4, and the closed-up photographed image acquired from the first photographing is also displayed in the region in which the sample image 521-1 was displayed, in place of the sample image 521-1.

Subsequently, when the second photographing is performed, the sample image 521-2 is displayed larger, and the background image 531-2 displayed on the right side of the live-view image display region 522 is accordingly moved to and displayed on the live-view image display region 522 with the background image 531-2 composited with the live-view image (the subjects are not depicted).

The photographing is sequentially performed as described above and, after the sixth. photographing, the photographing processing unit 302 controls the touch panel monitor 92, the speaker 233, and so on to provide guidance for the collage photographing. Subsequently, at Step S55, the photographing processing unit 302 performs the collage photographing as the seventh photographing.

As a result of the collage photographing, a collage photographed image is acquired that is made up of the image of the subject acquired from this photographing arranged along with a predetermined number of photographed images out of six photographed images acquired from the first photographing to the sixth photographing on a design image with a predetermined design, as the seventh photographed image.

In the collage photographing, the BGM output unit 325 may change the tempo of the music output as the BGM depending on whether filtering process is applied to the collage photographed image. In particular, whether the filtering process is applied to the collage photographed image makes up one of the photographing conditions (an aspect of the photographing). For example, if the filtering process is applied in the collage photographing, the BGM output unit 325 may output the music at a fast tempo and, if the filtering process is not applied in the collage photographing, the BGM output unit 325 may output the music at a slow tempo. Alternatively, it may change the music.

After the seventh photographing, at step S56, the display control unit 321 causes the touch panel monitor 92 to display an eye and brightness selection screen and the input receiving unit 322 receives instructions from the user, so that the eye and brightness selection unit 324 selects the eye size and the skin brightness of the subject (user) in the photographed images and processes the photographed images to change the eye size and the skin brightness of the subjects in the first to seven photographed images to the selected eye size and skin brightness.

After the process of Step S56 is finished and a predetermined time has elapsed, the BGM output unit 325 stops the output of the BGM (music) selected by the user in the initial service process and have been output via the speaker 233. The process then returns to Step S5 of FIG. 13 and the subsequent process steps are performed.

As described above, during the photographing process is performed, the music selected by the user in the initial service process is output as BGM from the speaker 233. More precisely, if the music selected by the user in the initial service process corresponds to the photographing condition such as the background set, the music corresponding to the photographing condition is output as the BGM. Therefore, in this case, for example, since the music matching the theme of the background set selected by the user, for example in accordance with the feeling of the day, is played as the BGM in the photographing space, the user can enjoy the photographing while listening to the BGM corresponding to the feeling at the time which is selected by the user from a large number of options of BGM without consuming time to search.

As described above, the output of the BGM is stopped when a predetermined time has elapsed after the eye size and the skin brightness are selected at Step S56. However, the output of the BGM may be stopped when a predetermined time has elapsed from the guiding for the movement to the edit space at Step S6 after the process returns to Step S5 of FIG. 13.

The user may not move from the photographing space to the edit space immediately after the guiding for movement to the edit space is performed. Therefore, stopping the output of the BGM immediately after the guiding for movement to the edit space is performed can bring a feeling of discomfort or strangeness to the user.

In contrast, stopping the output of the BGM when the predetermined time has elapsed after the guiding for movement to the edit space is performed can prevent bringing a feeling of discomfort or strangeness to the user who does not move to the edit space immediately after the guiding for movement to the edit space is performed.

Among background images composited with a live-view image and displayed in the live-view image display region 522 as depicted in FIG. 18, some background image includes, as described above, an image composited on the background of a subject in the live-view image, as well as a foreground image such as a stamp image or a frame image composited on the foreground of the subject.

Color tones, designs, shapes, arrangements, and so on of the background image displayed in the live-view image display region 522 and of the foreground image (such as the stamp image and the frame image) included in the background image may be changed depending on the BGM played in the photographing space.

For example, characters representative of the music title, or the lyrics of the chorus sections, of the BGM played in the photographing space maybe displayed on the stamp image included in the background image or on the background image itself, depending on such BGM.

Additionally, the photographing time in the photographing space may be changed depending on the BGM played in the photographing space. For example, if the BGM played in the photographing space is up-tempo music, a time length between one photographing and the next photographing may be made shorter and the number of times of photographing may be increased according to the reduced time. In this case, the user is allowed to select edit-target images to be subjected to the edit process out of the acquired photographed images.

The number or the light-emitting timing of strobes caused to emit light in the photographing space may be changed, or the poses in the model images displayed in the sample images 521-1 to 521-6 may be changed, depending on the BGM played in the photographing space. For example, in a case where the music “Happy Birthday to You” is output, the illumination apparatus 232 may be first lighted darkly as if candles are burning, subsequently it is once turned off as if the candles are blown off, and finally lighted brightly, and thereafter, the photographing may be performed.

The BGM played in the photographing space itself may appropriately be arranged and output. For example, the tempo (including a reproduction speed) and the sound volume of the BGM are set depending on the photographing conditions selected by the user in the initial service process. In this case, an image corresponding to the BGM or a promotion video (music video) of the music may be displayed in a predetermined region of the photographing screen 511. Moreover, changes may be made depending on the arranged BGM in the color tones, designs, shapes, arrangements, etc. of the stamp images or the like included in the background image, the light-emitting timing of strobes caused to emit light in the photographing space, and the poses in the model images displayed in the sample images 521-1 to 521-6 as described above. Ina case of photographing an image for SNS (social networking service) , the music may be output at a slow tempo during the photographing. In a case where the user selects a camera used in the photographing out of a plurality of the cameras 91 (for example, an upper camera and a lower camera), the music may be output at a fast tempo when the upper camera is selected, and may be output at a slow tempo when the lower camera is selected.

As described above, the reproduction start position of the output music is the chorus section thereof. However, the start position may be the beginning of the music.

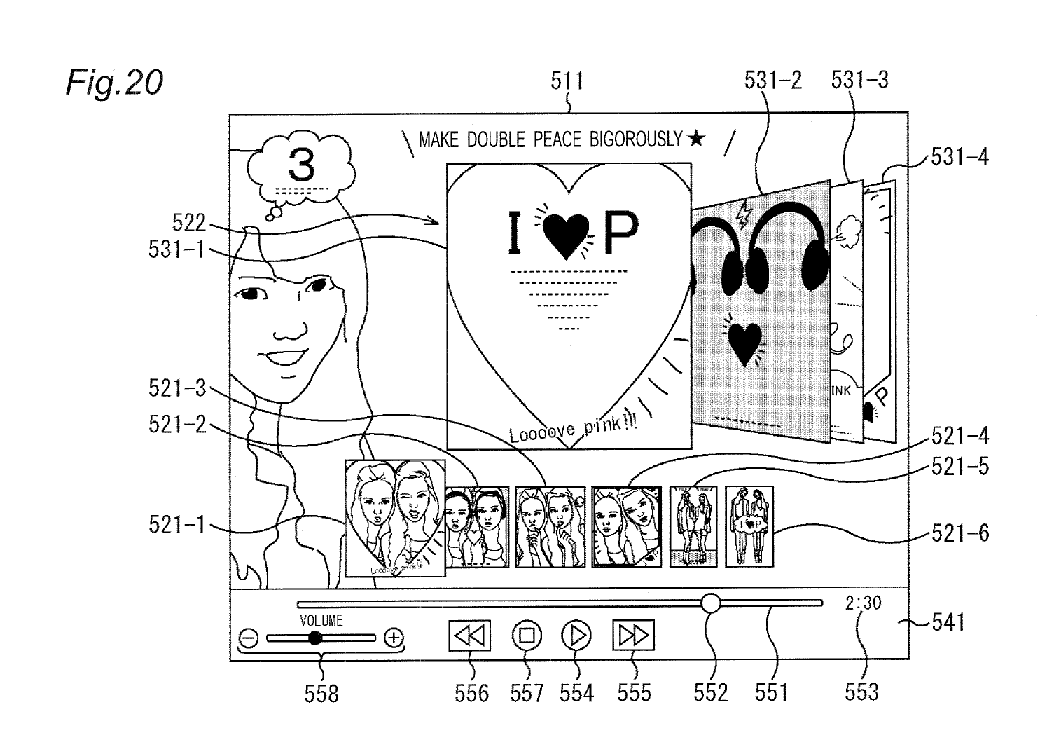

The user may be allowed to select the reproduction start position of the output music. In this case, as depicted in FIG. 20, the photographing screen 511 is disposed with a reproduction operation region 541 for allowing the user to perform an operation related to the reproduction of the output music.

When a slider 552 is moved in accordance with the operation of the user on a seek bar 551 in the reproduction operation region 541, the reproduction start position of the music is set, and a reproduction time 553 is displayed that indicates the reproduction start position or a temporal position during reproduction of the music on the right side of the seek bar 551.

If a reproduction button 554 is operated in this state, the reproduction of the music is started. During reproduction of the music, the music is subjected to fast-forward reproduction when a fast-forward button 555 is operated, and is subjected to rewind-reproduction when a rewind button 556 is operated, and the reproduction of the music is stopped when a stop button 557 is operated. When a sound volume adjuster 558 is operated, a sound volume of the music during reproduction is adjusted.

Such a configuration as above enables the user to specify a desired position of the music as a reproduction start position.

Other than setting the reproduction start position of the music with the position of the slider 552 on the seek bar 551, the music may be divided into a plurality of sections such as introduction, verse, bridge, chorus, and so on, and the user may be allowed to select the reproduction start portion.

In the edit process described above, a sticker layout is selected according to the user's selection. However, at least one of a plurality of sticker layouts which are subjects to be selected may be changed to a sticker layout corresponding to the BGM selected by the user in the initial service process, or the user may be allowed to select a sticker layout before selecting the BGM in the initial service process and at least one of the plurality of pieces of music which are candidates of BGM may be changed depending on the selected sticker layout.

As described above, since a user is allowed to enter an e-mail address of a portable terminal owned by the user in the edit process, the music selected in the initial service process, that is the BGM played in the photographing space, may be transmitted to the e-mail address, or an e-mail describing URL for downloading the music may be transmitted to the e-mail address.

In this case, loyalty points corresponding to the number of the played photo sticker creating games may be added to each user and, when the accumulated points reach a predetermined value, the music may be provided to the portable terminal owned by the user. It is arranged that the number and the points of the played photo sticker creating games can be checked by accessing a dedicated website from the portable terminal and the like.

A portable terminal or a portable music player owned by the user and the photo sticker creating apparatus 1 may be caused to communicate via a USB (universal serial bus) connector or wirelessly communicate through Bluetooth (registered trademark) or the like with each other to set music stored in the portable terminal or the portable music player as a candidate of the music for BGM.

Since a user's favorite music is usually stored in the portable terminal or the portable music player owned by the user, the user can certainly select the user's favorite music as the BGM to be played in the photographing space and can enjoy the photographing while listening to the favorite BGM.

For example, by having an original music matching the world view or concept of the photo sticker creating apparatus 1 provided by a famous artist as a piece of music defined as an option of the BGM, a user can play the photo sticker creating game with a special feeling in the photo sticker creating apparatus 1.

In the process described above, BGM to be played in the photographing space is selected in the initial service process. However, BGM may be selected in the edit process immediately after the movement from the initial service space to the photographing space.

A series of the processes described above can be performed by hardware or can be performed by software. If a series of the processes described above is performed by software, a program making up the software is installed from a network or a record medium and the control device 201 executes the program to perform a series of the processes described above.

For example, as depicted in FIG. 9, this record medium is made up of the removable medium 205 such as a magnetic disk (including a flexible disk), an optical disk (including CD-ROM and DVD), a magneto-optical disk (including MD), or a semiconductor memory distributed for delivering the program to an administrator of the photo sticker creating apparatus separately from the apparatus main body, and is also made up of the ROM 206 recording the program and a hard disk included in the storage device 202 preliminarily incorporated into the apparatus main body and delivered to the administrator.

In this description, steps describing the program recorded in the record medium obviously include process performed in described order in time series, and also include processes performed concurrently or individually even though the processes are not necessarily processed in time series.

A print medium in the above description is not limited to a sticker sheet or a photo paper. A print medium may be, for example, a paper or film of a predetermined size, a paper for a poster, a card such as a telephone card, or a textile such as a T-shirt. The image output has been described by taking printing to a sticker sheet or a photo paper as an example. However, the image output is not limited to print output. The image output includes, but not limited to, transmitting image data to a portable terminal (a user's portable terminal) via a server, and transferring image data directly to the user's portable terminal.

The embodiments of the present invention are not limited to the embodiments described above and various modifications are possible without departing from the spirit of the present invention. Though the present invention has been described by using the specific embodiments as above, various other variations and modifications and other usage of the specific embodiments are apparent to those skilled in the art. Therefore, the present invention is not limited to this specific disclosure and may be limited only by the appended claims.

This application relates to Japanese Patent Application No. 2013-264363 filed on Dec. 20, 2013, which is incorporated herein by reference.

What is claimed is:

1. An image outputting apparatus that photographs a user as a subject, allows the user to perform edit input to an acquired photographed image, and outputs the photographed image, comprising:
a photographing condition selection unit that selects a photographing condition related to the photographing; and
a music output unit that outputs music corresponding to the selected photographing condition during the photographing.

2. The image outputting apparatus according to claim 1, further comprising a background image to be composited on a background of the subject in the photographed image.

3. The image outputting apparatus according to claim 2, further comprising a background selection screen for selecting at least one background image out of a plurality of background images, wherein
the photographing condition is selection of the background image.

4. The image outputting apparatus according to claim 1, further comprising a music selection screen for selecting one music out of a plurality of pieces of music, wherein
the music selection screen includes a button for selecting music corresponding to the selected photographing condition and a button for selecting music independent of the selected photographing condition.
